(19) United States
(12) Patent Application Publication
(10) Pub. No.: US 2013/0317786 A1
(43) Pub. Date: Nov. 28, 2013

(54) FEATURE-BASED RAPID STRUCTURE MODELING SYSTEM

(71) Applicant: FLUOR TECHNOLOGIES CORPORATION, Aliso Viejo, CA (US)

(72) Inventor: Daniel Kuhn, Stilwell, KS (US)

(73) Assignee: FLUOR TECHNOLOGIES CORPORATION, Aliso Viejo, CA (US)

(21) Appl. No.: 13/901,966

(22) Filed: May 24, 2013

Related U.S. Application Data
(60) Provisional application No. 61/651,460, filed on May 24, 2012.

(51) Int. Cl. G06F 17/50

(52) U.S. Cl. CPC G06F 17/5004
USPC 703/1

(57) ABSTRACT

A feature-based rapid modeling system that enables a user to construct structural feature models from feature objects representing structural features. The interface enables the rapid construction by allowing for the use of group- and pattern-based feature objects, and by allowing a user to select feature objects based on object properties and object relationship properties, including hierarchical properties. A modeling engine constructs member models based on the feature models, which can be exported to a structure library. The models in the structure library can be imported into new projects, eliminating the need to repeat the construction of the model.

This application claims the benefit of U.S. Provisional Application No. 61/651,460, filed on May 24, 2012, U.S. Provisional Application No. 61/651,460, and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is construction modeling technologies.

### BACKGROUND

The construction industry leverages numerous construction modeling tools that allow designers or engineers to create computer models of a construction project. Such techniques are very beneficial when projects span years or billions of dollars. Unfortunately, many tools are cumbersome to use or fail to allow a user to rapidly model a structure. Further, existing toots require detailed information about structural elements in order to allow an engineer to combine the elements together to form a modeled structure. The Applicant has appreciated such detailed information is not necessarily required and that one can rapidly model a structure based on generic features of a construction, especially where generic features can be governed by a hierarchical structure of features, Such an approach gives rise to faster modeling and more compact design phases.

Others have put forth some effort toward modeling structures. For example, U.S. Pat. No. 5,552,995 to Sebastian, titled “Concurrent Engineering Design Tool and Method”, issued Sep. 3, 1996, is directed to the use of feature templates in constructing a model of a structure. Sebastian discusses a hierarchical knowledge structure, but fails to discuss wherein the possible combination of feature objects is governed by a hierarchical structure. Sebastian also fails to disclose a user interface that employs the hierarchical relationship between different feature objects to modify how a user can construct a model structure.

The Applicant's own U.S. patent application publication 2013/0035904 (“Kuhn”), titled “3D Plant Modeling Systems and Methods”, published Feb. 7, 2013, discusses plant modeling where primitives representing generic geometries can be used to build a plant model. While Kuhn discusses a relationship between the primitives, Kuhn does not discuss a hierarchical relationship among feature objects and the presentation thereof enabling the rapid modeling of structures.

U.S. patent application publication 2004/0073410 to Maly et al. titled “Computerized System and Method of Collaborative Structural Frame Development”, published Apr. 15, 2004, discusses conflict resolution in model building among a plurality of users via a hierarchical ranking of the users. Maly fails to disclose the building of a feature model using feature objects, and further fails to disclose the use of a hierarchical relationship between feature objects to assist in the rapid modeling of a structure.

U.S. patent application publication 2008/0077364 to Wakelam et al, titled “Computer-implemented Building Design and Modeling and Project Cost Estimate and Scheduling System”, published Mar. 27, 2008. Wakelam is directed to a parametric approach to constructing a model. Wakelam fails to disclose building a model using feature objects, and rapid modeling based on a hierarchical relationship of the feature objects, and the presentation thereof via an interface.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The recitation of ranges of values herein is merely intended to serve as a shorthand method of referring individually to each separate value fatting within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Although the above references do make advances in their respective area, they fail to provide for rapid modeling. The Applicant has appreciated as discussed below that organizing generic features in according to well defined construction patterns allows a design to create construction designs rapidly by allowing the design to access only feature that are contextually relevant to the construction patterns.

Thus, there is still a need for modeling systems capable of modeling structures based on features, and an interface that enables the rapid modeling of these structure based on the relationship between features.

### SUMMARY OF THE INVENTION

The inventive subject matter provides apparatus, systems and methods in which one can leverage a construction modeling system for rapid development a modeled structure. One aspect of the inventive subject matter includes a rapid construction modeling system comprising a structural feature database, a modeling interface, and a member modeling engine.

The modeling interface can enable the user to construct of a feature model using feature objects. The feature objects represent structural features within a construction (e.g., columns, beam, stairs, etc.), having feature properties representing the structural properties of the structural features. The feature objects can have sub-features, and the sub-features may be feature objects themselves. Having feature objects as sub-features of other feature objects can allow for the building of models of increased complexity, at various levels of granularity.

The modeling interface can present usable feature objects to a user according to a feature model's relationship to other feature models. The relationship between feature Objects can be hierarchical, and the modeling interface can present feature objects available for use with a currently selected feature object based on the hierarchy. Using the modeling interface, the user constructs a feature model using the feature objects.

The structural feature databases are used to store feature objects used in constructing the feature models. The structural databases can also store constructed feature models as feature objects, allowing for the use of previously-constructed structures or partial structures in new models.

The member modeling engine constructs a member model from the structure by analyzing the properties of the features objects in the feature model, then rendering a model of the structure accordingly. When the feature model is changed, the member modeling engine can entirely reconstruct the member model. Alternatively, the member modeling engine can update the existing member model to account for the changes. The modeling engine can configure one or more output devices a workstation, display, printer, etc.) to present the member model to a user.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an overview of the rapid modeling system.

FIG. 2 is an example of the modeling interface of the rapid modeling system.

FIG. 3 is an example of a structure library interface of the rapid modeling system.

FIG. 4 is an example of an export interface for transferring a model to another modeling tool.

FIG. 5 is an example of an import interface for importing a file into the rapid modeling system.

### DETAILED DESCRIPTION

It should be noted that while the following description is drawn to a computer/server based construction modeling system, various alternative configurations are also deemed suitable and may employ various computing devices including servers, interfaces, systems, databases, agents, peers, engines, controllers, or other types of computing devices operating individually or collectively. One should appreciate that such terms are deemed to represent computing devices comprising a processor configured or programmed to execute software instructions stored on a tangible, non-transitory computer readable storage medium (e.g., hard drive, solid state drive, RAM, flash, ROM, etc.). The software instructions preferably configure or program the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including the rapid generation of structural models for the design of real-world structural elements.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. With the context of this document, “coupled to” and “coupled with” are also used euphemistically to mean “communicatively coupled with” over a network.

One should appreciate that the feature database can store a wide variety of feature objects. In some embodiments, the feature objects can include one or more feature objects combined together as a pre-defined structure. Such structures can include certified structures that have been proven or otherwise validated for use in future projects. The certified structures can be certified according to various criteria (e.g., safety, loading, jurisdictional requirements or conditions, stress, construction firm requirements, etc.). Further, the pre-defined structures might include partial structures that comprise two or more feature objects, yet represent an incomplete structure. In a similar vein feature objects can comprise other feature objects. For example, a beam can comprise a feature object representing a mounting support.

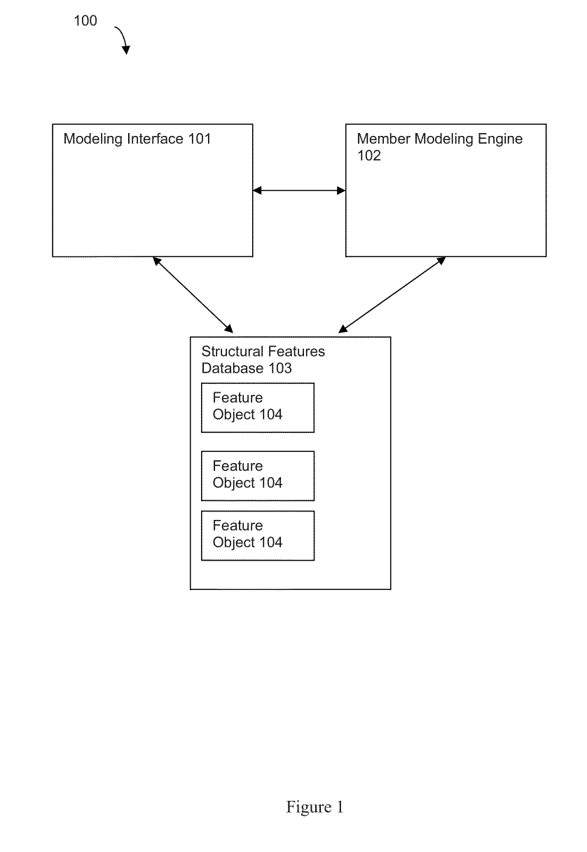

FIG. 1 provides an overview of the rapid modeling system 100 according to an embodiment. As shown in FIG. 1, the rapid modeling system 100 can include a modeling interface 101, a member modeling engine 102 and a features database 103. The features database 103 stores feature objects 104 used to construct models.

The modeling interface 101 (e.g., application, HTTP server, API, etc.) is used by a user to interact with the system and construct a structural model. The modeling interface 101 can include a client facing presentation of the modeling environment that enables the user to interact with the rapid modeling system. The modeling interface 101 can also include computer-readable instructions or logic that enable the modeling interface 101 to carry out various functions of the inventive subject matter, as described in further detail. The modeling interface 101 can receive user inputs via traditional computer user interfaces. Examples of these interfaces can include one or more of a keyboard, mouse, touch screen, stylus, motion sensor, camera or microphone, The user-facing aspects of the modeling interface 101 can be presented to a user via traditional computer output interfaces, including interfaces such as displays, audio output devices, browsers, and other sensory feedback devices such as tactile feedback devices.

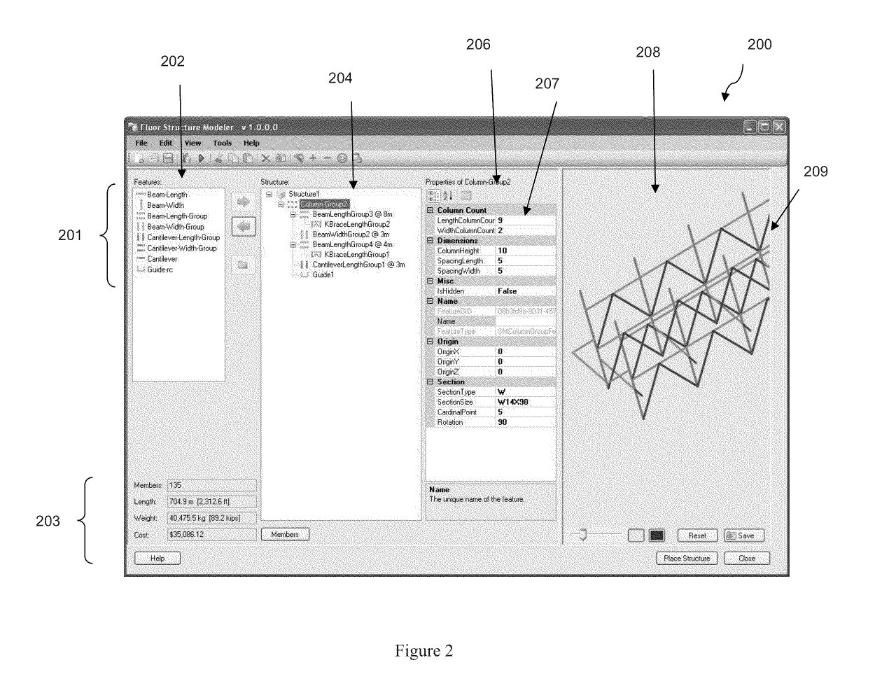

FIG. 2 is an example of the modeling interface 101 as presented to a user via the interface screen 200. In this embodiment, interface screen 200 is governed by a graphical user interface (GUI) operation on a computer workstation. The modeling interface 101 enables a user to select feature objects 104 and use them to construct feature models.

Feature objects represent structural features of a structure being modeled. In the example of FIG. 2, a list 201 of the feature objects 104 that a user may select from at any given time are presented in the box 202 A feature object 104 has feature properties that represent structural properties of the structural feature represented by the feature object. The feature properties of a feature object can include feature dimensions, feature spacing, coordinate points of origin, feature name, section type, section size, current rotation, cardinal point information, the material of the feature object, and the material grade of the feature object. As shown in FIG. 2, the feature properties corresponding to selected feature object “ColumnGroup2” are presented in the properties box 206.

Feature objects can be singular and represent a single structural feature, such as a single column or a beam. Feature objects can also include group feature objects, which represent a collection of multiple features according to a particular configuration or direction. The feature properties of group feature objects can include additional feature properties related to the group such as the number of individual features along at least one particular direction and the spacing between the individual features. For example, a column group feature can generate multiple columns along a length direction or width direction. In the example shown on FIG. 2, the feature object “ColumnGroup2” is a collection of nine columns along the length direction and two columns along the width direction forming a 2×9 grid of columns. In this example, the amount and direction of the columns of “ColumnGroup2” is displayed in the “Column Count” box 207 within properties box 206.

A feature object 104 can include one or more feature interfaces. A feature interface of a feature object includes information related to the ability of the feature object connects to other feature objects. The feature interfaces can be considered logical couplings or connectors that allow features to couple with each other to form a structure. The possible feature objects that a particular feature object can connect to can be determined according to one or more rule sets. The rule sets used to determine the possible feature objects can include one or more of a pre-defined list, a feature object hierarchy, a matching of feature properties, and conditions associated with feature property values of the feature objects being connected. The feature interfaces of a particular feature object can include identifiers of or pointers to feature objects that the particular feature object can connect to.

The list of features 201 presented to a user can be controlled by one or more of the feature interfaces and the feature properties of the selected feature object already in the feature model 204. When a user selects a feature object within the feature model 204, the modeling interface 101 will return the list of feature objects 201 according to the feature interfaces, thereby limiting the selectable feature objects in the list 201 to those that will work in the feature model. Additionally, if feature property values of the feature object within the model further reduces the number of available feature objects, the eliminated feature objects can be eliminated from the list 201. Alternatively, those feature objects can be left in the list 201, but grayed out and made unelectable by the user.

The feature interfaces can also include information related to the possible ways the particular feature object can connect to other feature objects. This information can include information related to the available points of connection between the feature objects, relative angles of connections, and a relative position of connection between the feature objects. For example, in FIG. 2, the feature object “BeamLengthGroup3” has the feature interface information “@8 m”, which indicates that the members of feature object “BeamLengthGroup3” connect with the members of “Column-Group2” feature object at a height of 8 meters.

The feature properties of a feature object 104 can have associated feature property values. A feature property can be pre-populated with default values based on established best-practices or with values corresponding to previously approved or certified feature objects.

Alternatively, a feature property can have a null value, which can remain null until a condition is met, typically when a user enters a value, For example, a feature object might include a beam that has a null value for its length. When the beam is combined with other feature objects to form a structure, the user can then enter a desired length by updating a corresponding property field in the modeling interface. In another alternative, the property value can be automatically assigned by the modeling engine based on other feature objects in a structure. Thus, feature objects lack a requirement for defined coordinates; origin, end points, or start points, for example.

The feature property values of a feature object can be user-modified. For example, a user can change the number of columns of the “ColumnGroup2” feature object by changing the numbers in the box 207. Changing a feature property value will cause a change of the feature object within the feature model, and thus change the overall properties of the feature model as a whole. Depending on the feature interface rules, changes to a feature property value of a feature object can create changes in other feature objects that the feature object is attached to. The feature interface rules of a feature object can include moving, rotating, modifying feature property values, and increasing or decreasing the number instances of a feature object to match the modification of an attached feature object.

The features interface can have default feature interface values or conditions that allow for the connection of feature objects without requiring user-designated conditions. For example, in FIG. 2, the feature object “BeamLengthGroup3” can have a default feature interface value of “@8 m”, causing the feature “BeamLengthGroup3” to automatically connect with the members of “Column-Group2” feature object at a height of 8 meters when the feature “BeamLengthGroup3” is added to the feature model.

A feature object 104 can have a hierarchical relationship with other feature objects. FIG. 2 illustrates the hierarchical relationship of the feature model 204, named “Structure 1” in this example, via a model tree view. The hierarchical relationship can be a “parent-child” hierarchical relationship, where a parent feature object can have a variety of child feature objects attached to it, A feature object can be a child feature object to a particular parent feature object while also being a parent feature object for other child feature objects. For example, in the feature model 204, the feature object “ColumnGroup2” is a parent feature object for the child feature objects “BeamLengthGroup3”, “BeamWidthGroup4”, “CantileverLengthGroup1” and “Guide1”. The feature objects “BeamLengthGroup3” and “BeamLengthGroup4” are, in turn, parent feature objects for the child feature objects “KBraceLengthGroup2” and “LBraceLengthGroup1”, respectively.

In a hierarchical relationship, feature objects of a particular hierarchical level can only directly attach to or interact with a feature object of the next highest level, and can only have feature objects attached to or that interact with it from the next lowest level. When a hierarchical relationship is used, the modeling interface 101 will only present feature objects that are child feature objects of a selected feature object. In FIG. 2, the features of list 201 presented to the user are all child feature objects of feature object “ColumnGroup2”.

Feature objects 104 are preferably not capable of connecting with feature objects of the same hierarchical level. This allows for the rapid visual modeling of a structure made up of multiple collections of feature objects of a particular hierarchy level without having to perform conflict checks. In this embodiment, the feature model can be exported to an external target design tool, and the conflict check can be performed after the feature model has been completed and exported by the user.

In another alternative, feature objects are capable of connecting or interacting with feature objects of the same level subject to conflict checking. In this embodiment, if a feature object is placed into a feature model in a way that would create a conflict (e.g., feature objects occupying the same space within the model, feature objects connected whose connections to One another exceed allowable tolerances, etc.), the system can resort to one or more conflict resolution rules to determine how to add the new feature object to the feature model. In one example, the feature objects can both be included as in the previous embodiment, and the interface will provide an indicator that the conflict exists. In another example, the feature objects are given preference according to chronological placement within the feature model. In this example, the system can modify the newly-added feature object to avoid a conflict. If the newly-added feature cannot be modified, the addition of the newly-added feature will not be permitted. in another example, the conflict of the feature objects can be resolved according to the properties of each of the feature objects, including selecting which feature object requires the least amount of modification to the rest of the feature model.

The feature objects of the highest available hierarchy level can be considered the most critical or foundational building blocks of a feature model. When a new structure is created, the interface presents can be configured or programmed to present only these feature objects as available feature objects to add to the empty feature model. Alternatively, the interface can be configured or programmed to allow a user to select the hierarchical level to use as a ‘starting point’ for the building of the feature model. This alternative allows for a user to construct and save feature models representing partial structures or sub-structures that can be imported and applied to other projects.

A feature object 104 can be a construction pattern set object. A construction pattern set object can have feature properties related to a pattern layout of the feature object when the feature object is included in sets of larger amounts. The larger sets represent a plurality of a singular instance of the feature object. Alternatively, the larger sets can represent a plurality of sets (e.g., pairs, groups of four, etc.) of the feature object. In a construction pattern set object, the members of the feature object are applied in repeating patterns. The feature properties of a construction pattern set object can include rules that dictate the pattern layout of the feature object. These feature properties set can be rules establishing a geometric or spatial layout of the multiple instances of the feature object and of the members of the multiple instances of the feature object. For example a construction pattern set object can be a feature object that attaches horizontal members to a series of columns, wherein the horizontal members alternate the attachment height to the columns along the length of the series of columns. In another example, a construction pattern set object can define that a feature object includes members in a repeating diagonal pattern along a series of columns.

The feature properties of a construction pattern set can also include additional feature objects necessary for the model structure to work at a larger scale. These additional feature objects can be child feature objects according to the feature object hierarchy.

The member modeling engine 102 constructs member models based on the feature models constructed using the modeling interface 101. The member modeling engine 102 generates the members that make up the member model based on the feature properties of each of the feature objects that make up the feature model. For each individual feature object within the feature model, the member modeling engine 102 can generate a feature member based on the feature properties of the feature object, Depending on the feature properties of a particular feature object, a feature member can be made up of more than one individual member.

FIG. 2 shows an example of a member model 209. The member model 209 can be in the form of wireframes or other 3-D models giving a visual depiction of the feature model 204, The member model 209 can be presented to the user via a box 208 the client-facing interface screen 200 of the modeling interface 101. The member modeling engine 102 can also cause an output device separate from the modeling interface. 101 to present the member model to the user. For example, the member modeling engine 102 can send the member model to a 2-D or 3-D printer for printing.

The member model 209 is generated for a particular feature model 204. Therefore, if a user makes a change to a feature model 204 such as adding or removing a feature object, or changing a feature object property, the modeling engine 102 constructs a new member model 209, reflecting the update.

The system can also include a reference database. The reference database can be used to store reference information regarding certain feature properties, such as constant values associated with a feature property or externally-obtained values associated with a feature property. The reference information can include structural information regarding a particular material (e.g., weight, density, structural properties, etc.) and the cost of a particular material. The reference database can be part of the structural features database 103 or a separate database. When a member model is constructed, the member modeling engine 102 can determine whether any of the feature properties of the feature objects used to make the feature model are associated with reference information stored in the reference database, and retrieves the reference information associated with these feature properties.

The member modeling engine 102 can use one or more of the information of the member model, the feature properties of the feature model and acquired reference data to present information to the user relevant to the structure being modeled. For example, in FIG. 2, the member modeling engine 102 can present the information 203 via the interface screen 200 such as the total number of members in the model, dimension information of the model such as its length, weight information and the estimated cost of the model based on information such as the amount of a particular material used in the model and the cost per amount of materials used. As the information 203 is gathered from the feature properties of the feature model 204 and the member model 209 generated based on the feature model 204, the information 203 can update in real time to account for any modifications a user makes to the feature model 204. Other information that can be presented to the user can include a resource count and compliance to a regulation, code or other pre-defined rule or restriction.

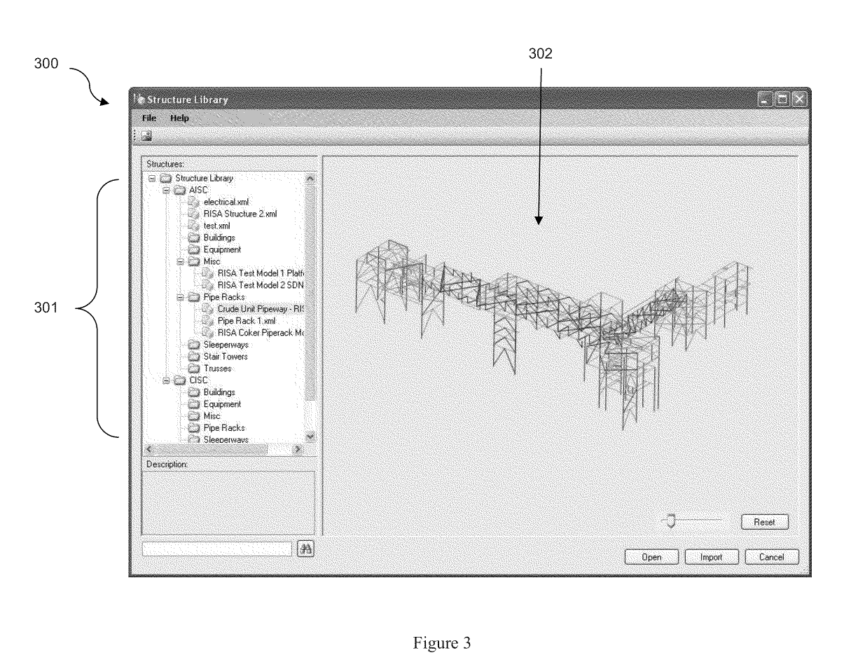

The modeling interface 101 can enable a user to access the feature database 103 to store and retrieve feature objects 104. The users can store feature models within a feature or structure library 300 as feature objects 104, as partial, completed or certified structure models, for future use in other structures. To find useful feature objects 104 within the structure feature database 103, users can submit one or more queries to the modeling interface, which in turn can search the structure feature database to find features objects 104 that satisfy the query. The feature objects 104 stored in the structure library 300 can be assigned structure names and metadata that allow for a user to search based on a desired structure or structural property. The query can take on many different forms including key words, certification requirements, project attributes, costs, Boolean operators, structured queries, natural language, or other forms. FIG. 3 is an example of a structure library 300 within feature database 103, listing the available structures in the library in window 301. As shown in FIG. 3, the selection of a stored feature model provides a preview of the member model in window 302.

The member modeling engine 102 is capable of causing an output device (e.g., a printer, a display screen, a browser, a 3D printer, etc.) to present the member model to the user. Further, the member model could comprise a serialized data format, possibly based on XML or other formats.

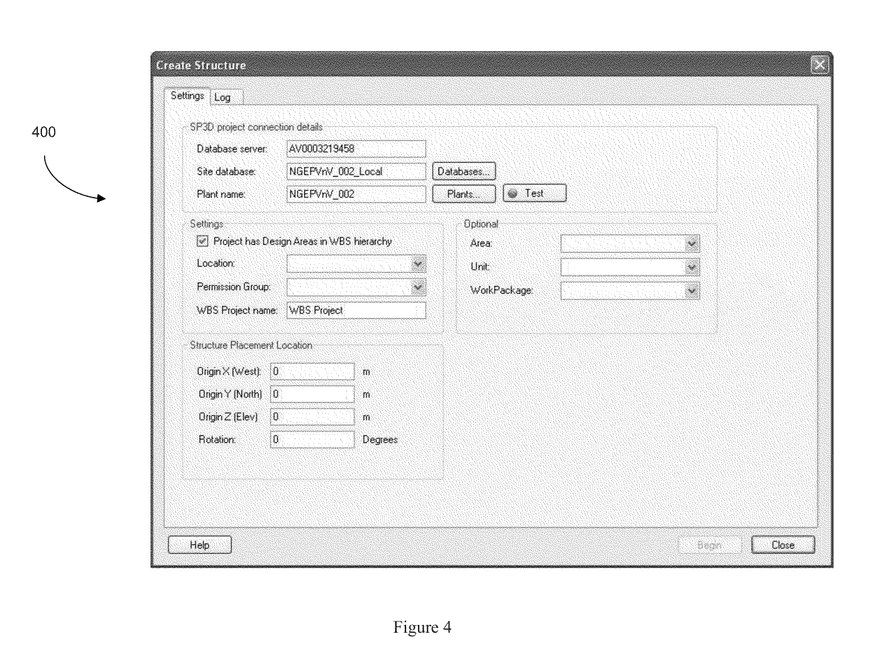

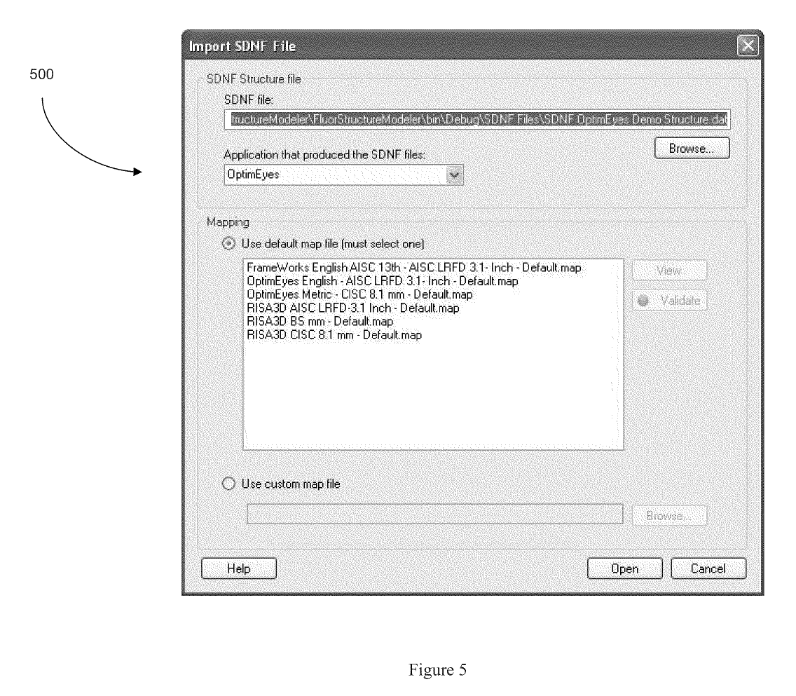

The member modeling engine 102 can export structures or member models according to one or more file formats to a target design tool as illustrated by interface menu 400 in FIG. 4. Preferred file formats comprise a common file format among the design tools, possibly based on Steel Detailing Neutral Format (SDNF). Exported structures can include additional information about the structure as derived from the member model or other sources. Example additional information can include a grid plane, catalog parts, member relationships, or other information. Similarly, modeling engine 102 can import objects via import interface menu 500, as illustrated in FIG. 5.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced, Where the specification claims refers to at least one of something selected from the group consisting of A, B, C . . . and N, the text should be interpreted as requiring only one element from the group, not A plus N, or B plus N, etc,

What is claimed is:

1. A rapid construction modeling system comprising:
a features database storing feature objects, each feature object representative of a structural feature and having a plurality of feature properties;
a modeling interface programmed to:
present a feature model having at least one existing feature object;
receive, from a user, a selection of an existing feature object within the feature model;
present at least one selectable feature object from the stored feature objects to the user as a function of at least one of:
the feature properties of the existing feature object; and
the feature properties of each feature object;
receive, from the user, a selection of at least one feature object from the at least one selectable feature object; and
update the feature model with the at least one selected feature object as a function of the selected at least one feature object's feature properties and the existing feature object's feature properties;
a member modeling engine programmed to:
construct a member model based on the updated feature model; and
cause at least one of the modeling interface and an output device to present the member model to the user.

2. The system of claim 1, wherein the feature properties of each feature object further comprise at least one hierarchical property.

3. The system of claim 2, wherein the at least one hierarchical property comprises an identifier of at least one of:
at least one parent feature object; and
at least one child feature object.

4. The system of claim 1, wherein the plurality of feature properties include at least two of: a count, a dimension, an origin coordinate, a section type, a material type, a material grade, and an orientation.

5. The system of claim 1, wherein the modeling interface is further programmed to:
receive at least one user-provided feature property value corresponding to at least one feature property of at least one of the feature objects in the feature model;
update the feature model based on the user-provided feature property values; and
wherein, in response to updating the feature model, the member modeling engine is further programmed to, in response to the updating of the feature model based on the user-provided feature property values:
construct an updated member model based on the updated feature model; and
cause at least one of the modeling interface and the output device to present the updated member model to the user.

6. The system of claim 1, wherein the feature objects further comprise construction pattern sets, and wherein the plurality of feature properties of each construction pattern set further comprises at least one pattern property.

7. The system of claim 1, further comprising a structure database storing pre-defined feature models comprising at least two feature objects.

8. The system of claim 7, wherein the pre-defined feature models comprise certified feature models representative of certified structural models.

9. The system of claim 7, wherein the pre-defined feature models comprises partial feature models representative of partial structures.

10. The system of claim 1, wherein the modeling interface is further programmed to:
receive a search query from the user;
identify at least one feature object within the structural features database based on the search query; and
present the identified at least one feature object to the user.

11. The system of claim 1, wherein the feature Objects further comprise feature interfaces and wherein the modeling interface is further programmed to, in response to receiving a user selection the at least one feature object:
logically couple the at least one selected feature object to the existing feature object as a function of the feature interfaces and the feature properties of the at least one selected feature object and the existing feature object.

12. The system of claim 1, wherein the member modeling engine is further programmed to export the member model as an exported structure to a target design tool.

13. The system of claim 12, wherein the exported structure comprises at least one of the following: a grid plane, a catalog part for a member, and a relationship among members.

14. The system of claim 12, wherein the exported structure comprises a common file format among multiple design tools.

15. The system of claim 14, wherein the common file format comprises a Steel Detailing Neutral Format (SDNF).

16. The system of claim 1, wherein the modeling interface is further configured to store the feature model as a new feature object within the structural feature database.

17. The system of claim 1, wherein the member model comprises at least one of a wire frame model and a three dimensional model.

18. The system of claim 1, wherein the member model comprises at least one of a member count, a structure size estimate, a total structure weight, a cost.
